(19) United States
(12) Patent Application Publication
(10) Pub. No.: US 2016/0063643 A1
(43) Pub. Date: Mar. 3, 2016

(54) COMPUTER PROGRAM, METHOD, AND SYSTEM FOR DETERMINING A TAXPAYER'S INCOME TAX WITHHOLDINGS BASED ON A SPECIFIED GOAL OF THE TAXPAYER

(71) Applicant: HRB Innovations, Inc., Las Vegas, NV (US)

(72) Inventor: Daniel D. Martin, Kansas City, MO (US)

(21) Appl. No.: 14/472,730

(22) Filed: Aug. 29, 2014

(51) Int. Cl. G06Q 40/00

(52) U.S. Cl. CPC G06Q 40/123

(57) ABSTRACT

A method, a system, and a computer program for enabling a taxpayer to achieve a specified goal realized by the taxpayer's income tax withholdings by providing a suggested income tax withholdings so that the taxpayer can satisfy their tax liability while knowing how much they will owe or receive back from a taxing authority. The specified goal may be a monetary value, a percentage, or a sliding scale. In embodiments of the invention, the suggested income tax withholdings includes a monetary amount and instructs the taxpayer on how to populate an income tax form to achieve the specified goal. Further embodiments use known tax information to predict the taxpayer's tax liability for a tax period.

### BACKGROUND

1. Field

Embodiments of the invention are directed to a method, a system, and a computer program for identifying an income tax withholding for a taxpayer based on the taxpayer's known and predicted tax information and for further enabling the taxpayer to specify a goal realized by the taxpayer's income tax withholdings based on the known and predicted tax information and a tax liability of the taxpayer.

2. Related Art

Many government taxing authorities, such as the Internal Revenue Service, deduct a monetary amount from an employed taxpayer's salary for payment of income tax. The deducted amount, which is referred to as “income tax withholdings,” is dependent on many factors related to the taxpayer's tax information and tax liability. A taxpayer may schedule their income tax withholdings by completing an income tax form, such as a W-4, and may further estimate their income tax withholdings by completing an allowances worksheet accompanying the income tax form. For clarity, other monetary amounts may be deducted from a taxpayer's salary, such as insurance or retirement investments. However, reference to income tax withholdings herein is intended to encompass the amounts deducted to pay for the taxpayer's tax liability.

Income tax withholdings forms and accompanying allowances worksheets do not seek detailed information to estimate the taxpayer's tax liability for determining the income tax withholdings. Instead, the worksheets and income tax forms make broad generalizations regarding the taxpayer's tax liability. This often results in the income tax withholdings being significantly under- or over-estimated to the detriment of the taxpayer. Alternatively, the taxpayer may use an income tax calculator to determine an amount of withholdings per pay period. However, income tax calculators do not calculate based on sufficiently detailed tax information for the taxpayer, nor are the income tax calculators able to allow the user to set a goal or anticipate trends of the taxpayer's tax liability. As a result, the taxpayer does not know how to fill out the income tax withholdings form based on a goal they wish to achieve.

### SUMMARY

Embodiments of the invention are broadly directed to assisting a taxpayer in determining income tax withholdings that realize a specified goal of the taxpayer related to their tax liability and income tax withholdings. In particular, embodiments of the invention determine the taxpayer's tax liability based on known tax information, such as can be obtained from prior year tax returns. The taxpayer may specify a goal realized by their income tax withholdings, such as receiving a tax refund of a particular amount. Alternatively, the taxpayer may set the specified goal generally equal to the taxpayer's tax liability so that no taxes are owed for a tax period but also that no tax refund is received. To be more accurate in determining tax liability, embodiments of the invention may predict the taxpayer's tax information for a portion of the tax period for which known tax information is not available. Embodiments may also allow the taxpayer to input known tax information to view how the income tax withholdings is affected. Embodiments of the invention use the known and predicted tax information to determine the taxpayer's tax liability. The income tax withholdings to achieve the specified goal can then be determined based on the tax liability. The suggested income tax withholdings may be presented as a monetary value, as instructions on how to fill out an income tax withholdings form to achieve the specified goal, and/or as an automatically populated income tax withholdings form to achieve the specified goal.

A computer program, a method, and a system of embodiments of the invention broadly comprises the steps of receiving, from the taxpayer, information indicative of a specified goal realized by the taxpayer's income tax withholdings for a preferred tax period; obtaining a known tax information related to the taxpayer's taxes; determining a tax liability for the taxpayer for a tax period based on at least a portion of the obtained known tax information; comparing the determined taxpayer's tax liability for the tax period with the received information indicative of the specified goal realized by the taxpayer's income tax withholdings; calculating, based on the comparing the taxpayer's tax liability with the received information indicative of the specified goal, a suggested income tax withholding that realizes the taxpayer's specified goal; and providing, to the taxpayer, the suggested income tax withholding.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the current invention are described in detail below with reference to the attached drawing figures, wherein:

FIG. 1 is a block diagram illustrating components for implementing embodiments of the invention;

FIG. 2 is a flow chart illustrating a plurality of steps implemented by the computer program, method, and system of embodiments of the invention;

FIG. 3 is a first screen capture depicting a graphical user interface of an embodiment of the invention;

FIG. 4 is a second screen capture depicting the graphical user interface of an embodiment of the invention; and

FIG. 5 is a third screen capture depicting the graphical user interface of an embodiment of the invention.

The drawing figures do not limit the embodiments of the invention disclosed and described herein. The drawings are not necessarily to scale, emphasis instead being placed upon clearly illustrating various features of embodiments of the invention.

### DETAILED DESCRIPTION

The following detailed description references the accompanying drawings that illustrate embodiments of the invention. The embodiments are intended to describe aspects of the invention in sufficient detail to enable those skilled in the art to practice embodiments of the invention. Other embodiments can be utilized and changes can be made without departing from the scope the invention. The following detailed description is, therefore, not to be taken in a limiting sense. The scope of embodiments of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Embodiments of the invention comprise a computer program, a method, and a system to access a taxpayer's known tax information to determine an income tax withholdings for the taxpayer. The taxpayer may further establish a specified goal that is realized by accurately calculating the taxpayer's income tax withholdings for the preferred tax period. For example, the taxpayer may set a goal for a particular tax refund amount, based on the taxpayer's determined tax liability. In yet further embodiments, the taxpayer's tax liability is determined based on known tax information and predicted tax information for the taxpayer. The specified goal does not alter the taxpayer's tax liability for a tax period but only affects the taxpayer's income tax withholdings for the tax period.

Embodiments of the invention broadly comprise, but do not necessarily require, the steps of presenting a request to a taxpayer to establish a specified goal related to the taxpayer's income tax withholdings for a preferred tax period; receiving, from the taxpayer, information indicative of the specified goal realized by the taxpayer's income tax withholdings for the preferred tax period; obtaining a known tax information related to the taxpayer's taxes; determining a tax liability for the taxpayer for the preferred tax period based on at least a portion of the obtained known tax information; comparing the determined taxpayer's tax liability for the preferred tax period with the received information indicative of the specified goal realized by the taxpayer's income tax withholdings; calculating, based on the comparing the taxpayer's tax liability with the received information indicative of the specified goal, a suggested income tax withholding that realizes the taxpayer's specified goal; and providing, to the taxpayer, the suggested income tax withholding.

It should be appreciated that the income tax withholdings discussed herein are for a particular taxpayer, although a user of the invention may be the taxpayer or a third party operating on behalf of the taxpayer, such as a professional tax preparer (“tax professional”) or an authorized agent of the taxpayer. Therefore, use of the term “taxpayer” herein is intended to encompass either or both of the taxpayer and any third party operating on behalf of the taxpayer. Additionally, a taxpayer may comprise an individual filing singly, a couple filing jointly, a business, or a self-employed filer.

As noted above, embodiments of the invention determine the income tax withholding for the preferred tax period. As used herein, a “tax period” is the period of time for which the taxpayer must file a tax return with the government taxing authority. For example, the Internal Revenue Service (“IRS”) requires that each taxpayer file an annual tax return based on a calendar year from January 1st to December 31st of the year. Therefore, the tax period for the IRS is the time period from January 1st to December 31st for a given calendar year. However, the tax period could also be based on a fiscal year that does not necessarily align with the calendar year. Other tax periods made be different lengths of time based on the time periods set by the particular government taxing authority.

The taxpayer may desire to determine their income tax withholdings for a preferred tax period and at various times within a particular tax period. For example, if the tax period runs from January 1st to December 31st of a calendar year, the taxpayer may use embodiments of the invention on July 1st of the tax period and desire to determine the income tax withholdings for a remainder of the tax period, i.e., from July 1st to December 31st. In this instance, the preferred tax period is July 1st to December 31st, i.e., the time period for which the taxpayer desires to determine income tax withholdings using embodiments of the invention. However, embodiments of the invention may determine income tax withholdings for the preferred tax period that would realize the taxpayer's goal for the entire tax period, i.e., from January 1st to December 31st of the annual tax year. Staying with the same example of the tax period running from January 1st to December 31st of a calendar year, the taxpayer could alternatively use embodiments of the invention on December 1st of the tax period but desire for the income tax withholdings to become effective on January 1st of the subsequent tax period, i.e., the next tax year. In this instance, the preferred tax period is the tax period subsequent to the current tax period during which the taxpayer actually uses the invention. The current tax period is defined as the tax period presently occurring when the taxpayer uses embodiments of the invention. Embodiments of the invention also contemplate obtaining tax information for prior tax periods, as discussed in detail below. A prior tax period, as used herein, is defined as any tax period occurring prior to the current tax period or the preferred tax period. Because the preferred tax period may be dependent on a period of time for which the taxpayer desires to calculate the income tax withholdings, the preferred tax period may be either the current tax period, a remainder of the current tax period, or a tax period subsequent to the current tax period.

The taxpayer's tax liability is based on tax rules and regulations set by a government taxing authority. The government taxing authority as used herein may be any local, state, or national government or agency that has an ability to levy a tax on a taxpayer. The taxpayer's tax liability will depend on several factors including, but not limited to, the following: the taxpayer's taxable income, dependents, allowances, deductions, filing as a single taxpayer, filing jointly with another individual, charitable contributions, retirement savings, educational loans, etc. Every tax period, the taxpayer must file a tax return to report and satisfy their tax liability. A tax return may be prepared by the taxpayer, such as by using self-preparation tax software, by a tax professional, or by a taxpayer representative. Although embodiments of the invention determine the taxpayer's tax liability, as discussed herein, embodiments of the invention do not change the taxpayer's overall tax liability or otherwise reduce, avoid, or defer the taxpayer's tax liability for the tax period. That is, the taxpayer's tax liability remains the same based on the rules and regulations of the government taxing authority.

As discussed in more detail below, embodiments of the invention use the known tax information to calculate the taxpayer's tax liability. In general, known tax information includes tax information for either or both of the current tax period to date or a prior tax period. For example, known tax information may include, but is not limited to, any of the following information: name, social security number, age, marital status, sex, address, country of residence, state of residence, state of employment, employer name and location, occupation/profession/trade, income, business expenses, tax bracket, prior tax returns, deductions, insurance coverage, number of dependents, dependent's information, dependent's income, student loan information, taxable property information, investment information, prior or current W-2s, prior and/or current income tax withholdings to date, or other information germane to calculating the taxpayer's tax liability. Known tax information may also be obtained from information that the taxpayer may have previously provided to a tax professional and that is otherwise stored by tax preparation software used and accessed by the tax professional. Known tax information may further be provided by the taxpayer to the computer program of embodiments of the invention. For example, the computer program may request the taxpayer provide known information, including any changes to the known information, such as an addition of a dependent or a change in the taxpayer's income.

In yet other embodiments, predicted tax information may also be used to calculate the taxpayer's tax liability. Embodiments of the invention may use the known tax information to predict tax information for the remainder of the current tax period, herein referred to as the predicted tax information. Predicting the predicted tax information will be discussed in more detail below.

### System and Hardware Overview:

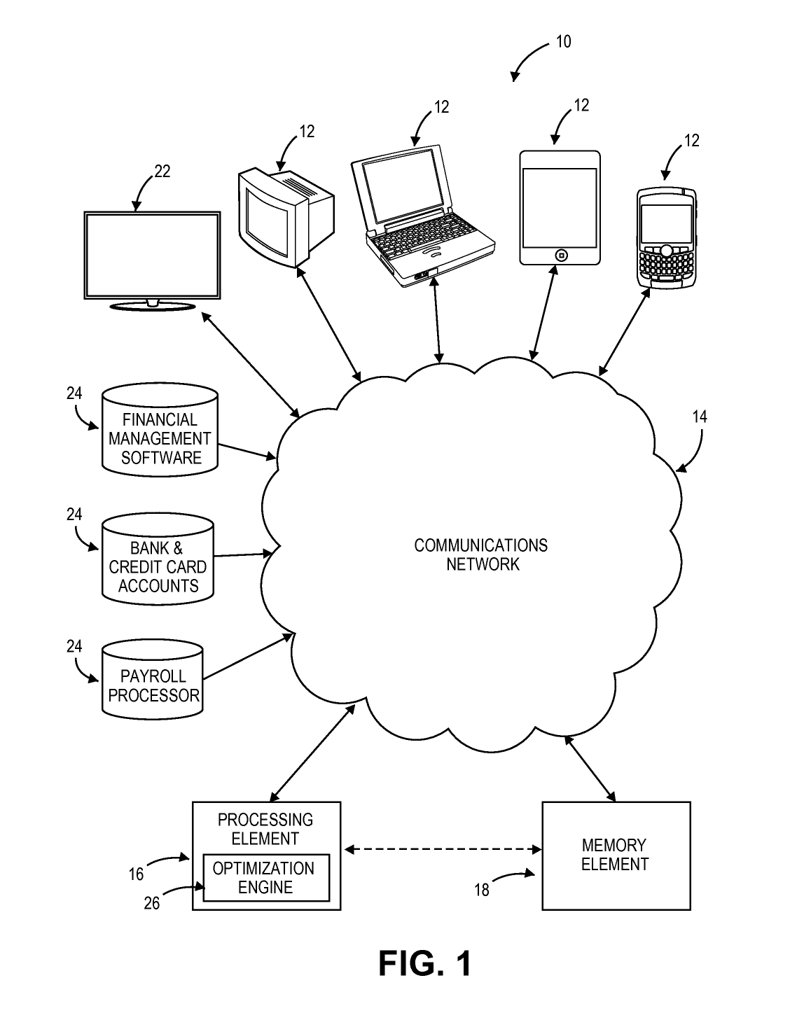

The computer program of embodiments of the invention implements various steps of the method of embodiments of the invention when executed by a computing device (which may also be referred to herein as a computing element). As shown in FIG. 1, the system 10 of embodiments of the invention may comprise computing devices 12 to facilitate the functions, features, and steps executed by the computer program, performed by the method, and otherwise described herein.

The computing devices 12 may comprise any number and combination of processors, controllers, integrated circuits, programmable logic devices, or other data and signal processing devices for carrying out the functions described herein, and may additionally comprise one or more memory storage devices, transmitters, receivers, and/or communication busses for communicating with the various devices of the system 10.

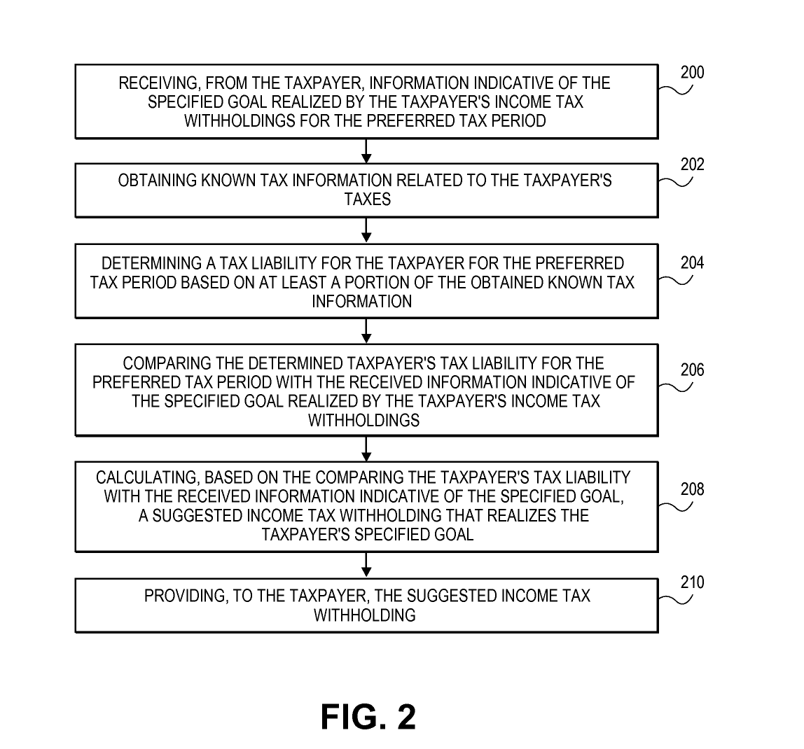

The computer program of embodiments of the invention comprises a plurality of code segments executable by a computing device 12 for performing the steps of various methods of the invention. The steps of the method may be performed in the order shown in FIG. 2, or they may be performed in a different order, unless otherwise expressly stated. Furthermore, some steps may be performed concurrently as opposed to sequentially. Also, some steps may be optional. The computer program may also execute additional steps not described herein. The computer program, system, and method of embodiments of the invention may be implemented in hardware, software, firmware, or combinations thereof, which broadly comprises server devices, computing devices 12, and a communications network 14.

The computer program of embodiments of the invention may be responsive to user input. As defined herein user input may be received from a variety of computing devices 12 including but not limited to the following: desktops, laptops, calculators, telephones, smartphones, or tablets. The computing devices 12 may receive user input from a variety of sources including but not limited to the following: keyboards, keypads, mice, trackpads, trackballs, pen-input devices, printers, scanners, facsimile, touchscreens, network transmissions, verbal/vocal commands, gestures, button presses or the like.

The server devices and computing devices 12 may include any device, component, or equipment with a processing element 16 and associated memory elements 18. The processing element 16 may implement operating systems, and may be capable of executing the computer program, which is also generally known as instructions, commands, software code, executables, applications (“apps”), and the like. The processing element 16 may include processors, microprocessors, microcontrollers, field programmable gate arrays, and the like, or combinations thereof. The memory elements 18 may be capable of storing or retaining the computer program and may also store data, typically binary data, including text, databases, graphics, audio, video, combinations thereof, and the like. The memory elements 18 may also be known as a “computer-readable storage medium” and may include random access memory (RAM), read only memory (ROM), flash drive memory, floppy disks, hard disk drives, optical storage media such as compact discs (CDs or CDROMs), digital video disc (DVD), and the like, or combinations thereof. In addition to these memory elements 18, the server devices may further include file stores comprising a plurality of hard disk drives, network attached storage, or a separate storage network.

The computing devices 12 may specifically include mobile communication devices (including wireless devices), work stations, desktop computers, laptop computers, palmtop computers, tablet computers, portable digital assistants (PDA), smart phones, and the like, or combinations thereof. Various embodiments of the computing device 12 may also include voice communication devices, such as cell phones and/or smart phones. In preferred embodiments, the computing device 12 will have an electronic display 22 operable to display visual graphics, images, text, etc. In embodiments, the computer program facilitates interaction and communication through a graphical user interface (GUI) that is displayed via the electronic display. The GUI enables the user to interact with the electronic display by touching or pointing at display areas to provide information to the system 10.

The communications network 14 may be wired or wireless and may include servers, routers, switches, wireless receivers and transmitters, and the like, as well as electrically conductive cables or optical cables. The communications network 14 may also include local, metro, or wide area networks, as well as the Internet, or other cloud networks. Furthermore, the communications network 14 may include cellular or mobile phone networks, as well as landline phone networks, public switched telephone networks, fiber optic networks, or the like.

The computer program may run on computing devices 12 or, alternatively, may run on one or more server devices. In embodiments of the invention, the computer program may be embodied in a stand-alone computer program (i.e., an “app”) downloaded on a user's computing device 12 or in a web-accessible program that is accessible by the user's computing device 12 via the communications network 14. As used herein, the stand-alone computer program or web-accessible program provides users with access to an electronic resource from which the users can interact with various embodiments of the invention.

The code segments and any corresponding source code forming the computer program serve to implement an optimization engine 26 of embodiments of the invention. The optimization engine 26 is shown as being executed by the processing element 16 in FIG. 1, although it should be appreciated that some or all of the code segments forming the computer program may be stored on one or more memory elements 18 and may be executed by at least one computing device 12.

Embodiments of the invention allow for the taxpayer to create and access a taxpayer profile. The taxpayer may edit, revise, populate, or otherwise modify the taxpayer profile with tax information related to the taxpayer. Additionally, the taxpayer may upload to, save, or otherwise associate the taxpayer profile with a source of known tax information 24, as shown in FIG. 1. For example, the taxpayer may associate the taxpayer profile with a plurality of sources of known tax information 24, such that the taxpayer profile is populated with known tax information automatically and electronically pulled from the plurality of sources 24. Exemplary sources of known tax information 24 include, without limitation, financial management software, a bank and credit card accounts for the taxpayer, investment accounts for the taxpayer, an existing account with a tax professional, a payroll processor, self-tax preparation tax software, a previously filed tax return, a W-2 for the taxpayer, and a pay stub. In the computer program of embodiments of the invention, known tax information may be provided directly from the taxpayer through the GUI by allowing the taxpayer to enter tax information via the computer program. In general and in addition to the above, the source of known tax information 24 may include any one of the above plurality of sources, a database of taxpayer information, or any combination thereof. Furthermore if the embodiment is associated with an electronic source of known tax information (e.g., a bank account, financial management software, etc.), the taxpayer profile may continuously update the known tax information as new or changed information is associated with the respective source of tax information.

Embodiments of the invention may be accessible to the taxpayer via the computer program. For example, the computer program may be implemented via an electronic resource, such as a website or an app. Although not required, the taxpayer profile may be accessed via an authentication process, such as requiring a username and passcode.

### Operation of Embodiments of the Invention

Referring now to Step 200 of FIG. 2, embodiments of the invention receive information indicative of the specified goal realized by the taxpayer's income tax withholdings for the preferred tax period. Prior to receiving the specified goal, embodiments of the invention may present a request to the taxpayer to establish the specified goal realized by the taxpayer's income tax withholdings for the preferred tax period. The goal can either be a monetary amount, a percentage value, a sliding scale, or an instruction for a particular action, such as the income tax withholdings are a sufficient amount that the taxpayer does not owe taxes for the tax period. The specified goal may be dependent upon or otherwise affected by the taxpayer's tax liability and be within a pre-set tolerance of error. By way of example, the taxpayer may enter a goal of a $500 tax refund. This allows the taxpayer to take every precaution not to owe a tax penalty at the end of the tax period. Furthermore, it allows the taxpayer to use the income tax withholdings as a savings plan and receive the monetary amount, i.e., the $500, as a tax refund from the government taxing authority. Conversely, by way of example, the taxpayer may enter a goal of owing $500 to the government taxing authority. The taxpayer may desire to owe money for the tax period because the taxpayer knows it will receive a bonus from its employer to pay for the $500 owed to the government taxing authority and would prefer to have a larger paycheck throughout the tax period. This allows the taxpayer to be sure they do not set aside any more income than necessary to meet their tax liability. In such an instance, embodiments of the invention will instruct the user if the goal would incur any penalties or interest with the government taxing authority, as discussed in more detail below. In yet other embodiments, the goal may be a percentage value related to the taxpayer's liability. For example, the user may decide to enter a percent value of zero. This value indicates that the taxpayer wishes to only withhold the exact amount required to satisfy their liability for the tax period.

It should be appreciated that the specified goal may accommodate some pre-set tolerance of error and thus, embodiments of the invention may realize the specified goal even if not realizing exactly a dollar amount of the specified goal. For example, if the taxpayer's specified goal is to have a tax refund of $500, it may be that the tax refund actually realized is $475. Embodiments of the invention encompass relatively small deviations between the specified goal and a realized goal. That is, embodiments allow for a pre-set tolerance of error, which can be a set dollar amount (e.g., +/−$50 from taxpayer's specified goal) or a set percentage (e.g., within 10% of taxpayer's specified goal). In general, it should be appreciated that even though a specified goal is set, an actual tax liability for a tax year will be based on the accuracy of predicted tax information. Thus, embodiments of the invention, as discussed below, estimate the tax liability for the taxpayer based on known tax information and predicted tax information and use the estimated tax liability to set the income tax withholdings to realize the specified goal. However, the actual tax liability—and resulting tax refund amount or taxes owed, as the case may be—will vary based on changes in the taxpayer's tax information through a remainder of the current tax year, changes in the tax law, etc.

In alternative embodiments, the goal may be an instruction for a particular action. For example, embodiments may present to the user options for goals, such as any of the following: owe less than $X at end of tax period; minimize withholdings while insuring a tax liability, including any tax payment when filing the tax return, that does not incur penalties or interest by the government taxing authority; minimize withholdings while insuring no tax payment when filing the tax return; receive less than $X at end of tax period; and owe no taxes at end of tax period. The taxpayer could first be presented a risk analysis questionnaire for identifying a comfort level of having to owe taxes at the end of the tax period. For example, the questionnaire, which is presented on the GUI to the taxpayer, asks the taxpayer if owing taxes at the end of the tax period is acceptable. The questionnaire could include the caveat that the taxpayer would not otherwise owe any penalties or interest. The questionnaire could further ask the taxpayer if it is acceptable if they owe less than a specific dollar amount or percentage of income. In response to the taxpayer's answer to this questionnaire, the taxpayer could then be presented with different actions for the specified goal, as discussed above.

Returning again to FIG. 2, the computer program, method, and system of embodiments of the invention may first present, on the display and via the GUI, a request to enter the specified goal. The taxpayer may then accept the request to enter the specified goal via the GUI. Embodiments of the invention may then receive information indicative of the specified goal, as noted above and shown in Step 200. The request to enter the specified goal can be presented via a drop-down menu of select actions, such as “receive tax refund of $X,” or the taxpayer can type into a pre-set field their specified goal. However, the request to enter the specified goal could be presented as a slider that includes a range of tax liability and tax refund, e.g., a range of −$500 (i.e., the taxpayer owes $500 at the end of the tax period) to +$500 (i.e., the taxpayer receives a tax refund of $500 at the end of the tax period). The taxpayer can then input the specified goal by sliding the slider. Based on the specified goal, embodiments of the invention will provide an income withholdings report to the taxpayer, which may be displayed on the GUI and which may be printed, saved, or otherwise stored by the taxpayer. The report may include other useful information, such as a predicted tax liability, tax deductions, tax allowances, and individual taxpayer withholdings of a dependent.

In additional embodiments, the known tax information may include a frequency of a payroll distribution to the taxpayer. Embodiments of the invention may then calculate the net pay to the taxpayer for each payroll distribution. The taxpayer can then see how a particular specified goal will change the net pay for each payroll distribution. In embodiments, the input for the specified goal and the net pay to the taxpayer are displayed on the same window of the GUI so that the taxpayer may view these two items of information together. In an embodiment where the taxpayer can easily input various specified goals to determine how each goal affects the taxpayer's net pay, the taxpayer may selectively choose a plurality of specified goals to determine the affect on net pay.

In other embodiments of the invention, the taxpayer may be presented with an option to select a plurality of goals for the tax period for a plurality of different time periods within the preferred tax period. Multiple goals could include a first goal for a first time period of the preferred tax period and a second goal for a second, remaining time period of the preferred tax period. For example, the taxpayer may wish to withhold less from their income for the first several months of the preferred tax period. In this example, the first specified goal could be a first monetary amount for the first time period of the preferred tax period. As such, the taxpayer would also provide a second specified goal of a second monetary amount for the second time period and a date at which the second specified goal should be initiated. Embodiments of the invention could then insure that the income tax withholdings for the second time period are sufficient to realize the second specified goal. In yet further alternatives, the withholdings for the second time period could be sufficient so that the cumulative withholdings satisfies an overall goal established by the taxpayer, such as not owing taxes at the end of the tax period. For example, the taxpayer may first establish a cumulative specified goal of a $1,000 tax refund for the tax period. However, and merely as an example, the taxpayer would like more income tax withholdings during the first three months of the tax period than the latter 9 months of the tax period due to the taxpayer's bonus structure. Thus, the taxpayer may establish the first specified goal for the first time period of three months to withhold X % of a needed cumulative income tax withholdings for the tax period; and the taxpayer may also establish the second specified goal for the second time period of nine months to withhold (100−X) % of the needed cumulative income tax withholdings for the tax period. The taxpayer is thus able to set, to a high degree, the taxpayer's income tax withholdings based on various factors affecting the taxpayer (e.g., bonus, expected inheritance, expected income if income is inconsistent throughout the tax period, etc.).

Embodiments of the invention may calculate and suggest to the taxpayer a default goal, including displaying on the GUI the default goal and a resulting default income withholdings report. A default goal is generated based on known tax information and predicted tax information, if any, and the known tax information is used to calculate the taxpayer's tax liability. The default goal may also be based on a limited amount of known tax information or a specific item of known tax information. For example, the taxpayer may be requested to provide only a few items of known tax information, such as income, number of dependents, and an estimate of mortgage interest paid each tax period. The default goal may then be calculated based on this limited quantity of known information.

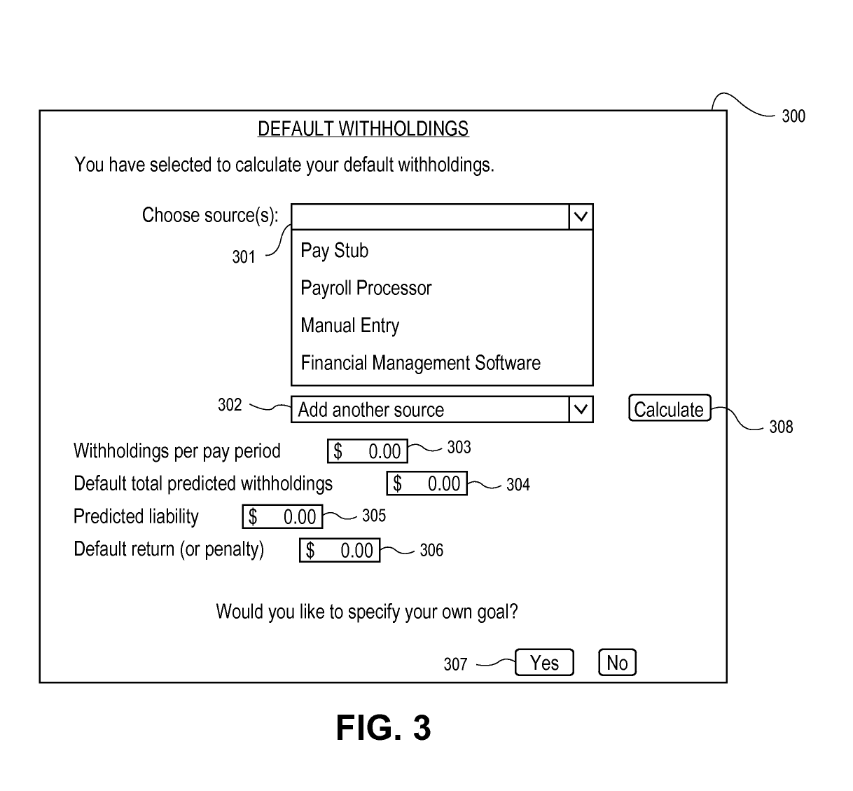

FIG. 3 is a screen capture depicting how a taxpayer may interact with a GUI 300 for calculating a default goal on a computer program of embodiments of the invention. The computer program may present an option to choose the source of known tax information 301. The taxpayer is not limited to one source, as the taxpayer may also choose additional sources of known tax information 302. Choosing a greater amount of sources of known tax information may increase the accuracy of the calculation. The taxpayer may then instruct the computer program to calculate 308 the default goal 306. After the calculations are performed, the embodiment may display a default withholdings per pay period 303 alongside a default total predicted withholdings 304. In addition, a predicted tax liability 305 may be displayed alongside the resulting default goal 306. The taxpayer may then choose to specify their own goal 307 if they are not satisfied with the default goal 306. To clarify, this default goal represents no change to the current income tax withholdings form.

Before or in conjunction with presenting the request to the taxpayer to establish the specified goal, embodiments of the invention may ask the taxpayer if the taxpayer desires to change their existing income tax withholdings. The existing income tax withholdings may be obtained from the known tax information, such as a current income tax withholdings form, the pay stub, the payroll processor, or the financial management software. A withholdings to date will then be calculated from the known tax information and will be projected for the remainder of the tax period. The taxpayer's tax liability at the end of the tax period based on the withheld and projected income tax withholdings is presented to the taxpayer. If the taxpayer is satisfied with the tax liability, including any amount owed to the government taxing authority or any tax refund, then the taxpayer can elect to continue their income tax withholdings for the remainder of the tax period based on the withholdings to date. However, if the taxpayer desires to change their income tax withholdings to achieve a specified goal, the taxpayer may select to identify the specified goal.

In yet further embodiments, the taxpayer's income tax withholdings and/or the taxpayer's tax refund or taxes owed for at least one prior tax period may be obtained (such as through self-preparation tax software or from a tax professional), and the tax refund or taxes owed may be presented to the taxpayer on the GUI. The taxpayer may then be asked if the taxpayer desires to select, as the specified goal, the tax refund/taxes owed for at least one of the prior tax periods. Moreover, the embodiment could calculate and average tax refunds or taxes owed from at least two prior tax periods and use this amount as the taxpayer's specified goal. In yet further variations of this embodiment and because the taxpayer's circumstances affecting their tax liability could have changed significantly from the prior tax periods (e.g., the addition of another dependent), this embodiment will account for the changes of known tax information.

Referring to FIG. 2 and as noted above, embodiments of the invention obtain the taxpayer's known tax information to determine the taxpayer's income tax withholdings for the preferred tax period, as set forth in Step 202. The known tax information is acquired from the various sources discussed above, such as the taxpayer's financial management software, self-preparation tax software, a payroll processor, or directly input into the computer program of embodiments of the invention. If the taxpayer returns at a later date to use an embodiment of the invention so that the known tax information is not up to date, a request will be presented to update any tax information that is indicative of changes in the taxpayer's liability. For example, a request may be presented to the taxpayer through the GUI if the taxpayer has not updated their tax information from a prior tax period.

Known tax information may also be obtained from the taxpayer. For example, the taxpayer may be presented with a variable field (i.e., a drop-down menu) in which the taxpayer may select a single category relevant to tax liability (e.g., number of dependents, salary, etc.). The taxpayer may then select the single category and input the corresponding known tax information. Using the known tax information from the single category, a first suggested income tax withholding is presented to the taxpayer. To determine how additional known tax information may further affect the suggested withholdings, the taxpayer may select a second category from a second variable field and input the corresponding known tax information. A second suggested income tax withholding, which may be different than said first suggested income tax withholding, is presented in combination with the first suggested income tax withholding. Thus, the taxpayer may receive different suggested income tax withholdings based on the taxpayer's input through the interface.

In further embodiments, known tax information may be obtained by importing information related to the taxpayer's tax liability from a plurality of sources. Similar to the taxpayer profile, and by way of example, the taxpayer may choose to synchronize and import the known tax information from financial management software, a bank account, payroll processor, or tax preparation software. As such, the embodiment of the invention imports tax information relevant to tax liability from data stored in these sources. This importation and synchronization could occur once or continuously through linking the embodiment of the invention to these sources.

Embodiments of the invention may also predict tax information for the remainder of the current tax period or for the preferred tax period, and the predicted information may be used individually or in conjunction with the known tax information to determine the income tax withholdings. The predicted tax information may be at least partially based on the known tax information. U.S. Pat. No. 8,706,580, filed Apr. 26, 2010, and entitled “Method, System, and Computer Program for Predicting Tax Liabilities and Benefits” (“the '580 Patent”), describes a computer program, method, and system for predicting tax information for a taxpayer. The '580 Patent is assigned to the assignee of the present application, and the disclosure of the '580 Patent is incorporated by reference herein in its entirety.

Embodiments of the invention predict tax information for a remainder of the current tax period or for a subsequent tax period by analyzing a trend of changes in the taxpayer's tax information. For example, if the known tax information includes the taxpayer's salary for three previous tax periods, and from this known salary information, a percentage increase in salary each tax period can be calculated, then the percentage increase can be applied to predict the taxpayer's salary for the preferred tax period. Embodiments of the invention can track the trends of other known tax information, such as trends in deductions, additional taxable income, savings, investments, and tax liability as a whole. For example, if the taxpayer has average charitable deductions of $2,000 for each of one or more prior tax periods, then this information can be used to statistically predict the taxpayer's charitable deductions for the preferred tax period. Embodiments of the invention may also allow the taxpayer to update the known tax information with any significant changes that may affect the taxpayer's tax liability, such as a loss of income, an addition of a spouse, an addition of a dependent, etc. As such, determining the tax liability for the taxpayer for the current tax period is based on at least a portion of the updated tax information.

Once the known tax information is obtained, the taxpayer's tax liability is determined based on at least a portion of the known tax information, as set forth in Step 204. Embodiments of the invention determine the taxpayer's tax liability based on at least a portion of the known tax information for the taxpayer, which, as noted above, may also include the income tax withholdings to date for the preferred tax period. Embodiments may also determine the taxpayer's tax liability based on both known and predicted tax information. As noted above, the tax liability is determined by applying the tax rules and regulations of the government taxing authority. Embodiments of the invention may thus include or otherwise have access to a tax liability calculator that is programmed to apply these rules and regulations.

Another embodiment determines the taxpayer's tax liability by analyzing known and/or predicted tax information and comparing the tax information to a tax liability database for other, third party taxpayers. The tax liability database includes tax information for filed tax returns for the third party taxpayers. The filed tax returns may be filed through a tax professional, such that the tax information is obtained from the previously filed returns (with consent from the third-party taxpayer). Alternatively, the tax information may be obtained from demographic research by a third party. The tax liability database includes factors that are potentially indicative of tax liability, including occupation, age range, region of the country, salary ranges, family size, spending habits, county of residence, level of education, net worth, and/or average yearly savings. The embodiment uses the known and/or predicted tax information to determine the taxpayer's liability. In this embodiment, the determined tax liability may not be as accurate because it is not relying completely on known tax information for the taxpayer; however, the taxpayer may then be advised of a probability of the accuracy of the calculated tax liability.

Referring now to Step 206, once the taxpayer's tax liability is determined for the preferred tax period, embodiments of the invention compare the determined tax liability with the received information indicative of the specified goal realized by the taxpayer's income tax withholdings. In this step, the tax liability for the taxpayer is calculated and known; the income tax withholdings, if any for the preferred tax period to date, is known; and the taxpayer's specified goal is known.

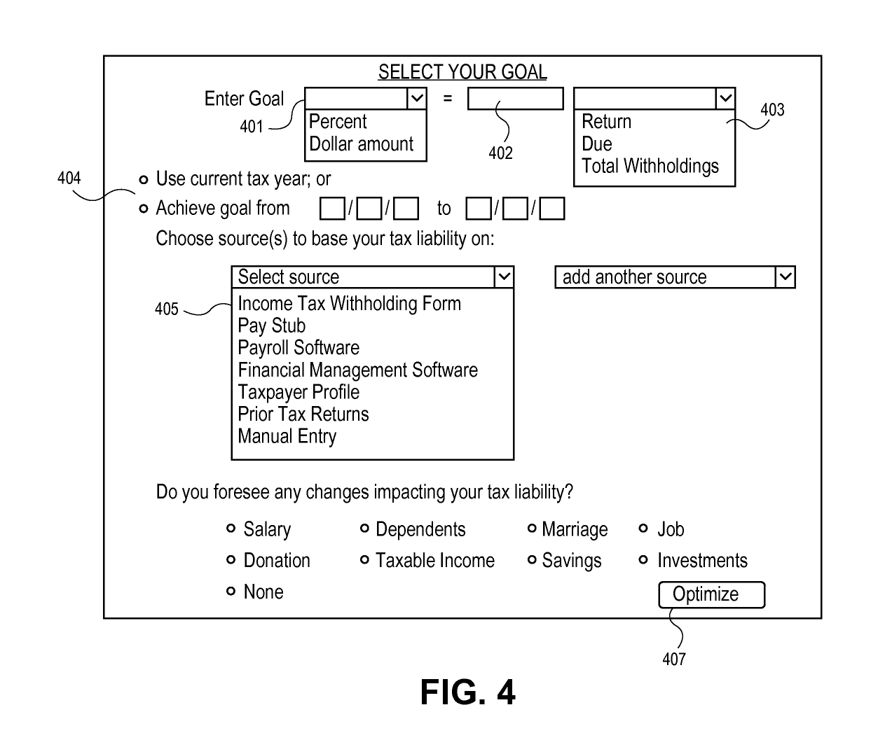

Referring to FIG. 4, the taxpayer may choose a dollar amount 401 and enter a specified goal 402. Next, the taxpayer may select 403 whether the specified goal represents a tax refund, an amount due, or a total income tax withholdings. The taxpayer may then select a time period 404 for which to achieve the specified goal as discussed in more detail above. Next, the taxpayer may choose a source of known tax information 405 to calculate the taxpayer's tax liability. In addition, the taxpayer may select a multiple of other sources of known tax information 406, as this improves the accuracy of realizing the specified goal. If the taxpayer foresees any changes that may impact their liability, the taxpayer may select 406 any changes that may apply and proceed to optimize their withholdings 407.

As a non-limiting example, the taxpayer's tax liability may be $20,000, and the taxpayer's specified goal is a tax refund of $1,000. If the taxpayer is using embodiments of the invention on July 1st of an annual tax period to determine the remainder of the tax period's income tax withholdings, and the known tax information includes that the taxpayer has income tax withholdings to date of $12,000, then embodiments of the invention will calculate, based on the comparing of the tax liability with the specified goal, a suggested income tax withholding that realizes the taxpayer's specified goal, as set forth in Step 208. This calculation will encompass a time remaining for the preferred tax period and the income tax withholdings that the taxpayer will still be able to withhold. Embodiments then calculate an amount of income tax withholdings for the remainder of the preferred tax period to satisfy the taxpayer's tax liability and achieve their goal. Using the above example, the taxpayer has 6 months of additional income tax withholdings for the remainder of the preferred tax period. The calculated tax liability of $20,000 is decreased by the income tax withholdings of $12,000 withheld from January 1st to June 30th to obtain $8,000 in income tax withholdings for the remainder of the tax period. The specified goal of a $1,000 tax refund is then compared to the $8,000 in needed income tax withholdings to generate a suggested income tax withholding of $9,000 for the remainder of the tax period (i.e., the $8,000 remaining amount needed to satisfy a tax liability of $20,000 and the $1,000 specified goal for a tax refund).

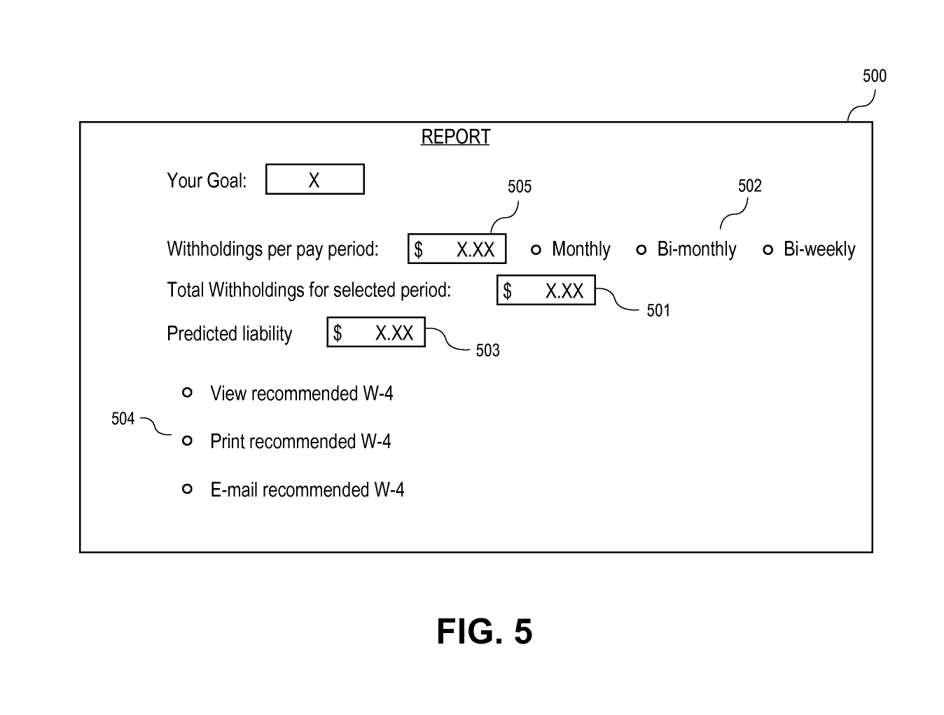

As set forth in Step 210 and referring to FIG. 5, the suggested income tax withholdings of $9,000 for the remainder of the preferred tax period is then provided to the taxpayer, such as presenting on the GUI 500. In addition, the taxpayer's predicted liability 503 may be presented alongside options 504 to view the suggested income withholding via a recommended income tax withholds form, as discussed in more detail below. Moreover, the taxpayer may be presented an option to select a frequency of distribution of the income tax withholdings based on a payroll distribution frequency 502. For example, the GUI may present a drop-down box or other input where the taxpayer may select a payroll distribution frequency of monthly, bi-monthly, every two weeks, etc. Alternatively, this information may be obtained from the taxpayer earlier in the process and with the collection of the known tax information or as part of preliminary requests for information presented to the taxpayer. In yet further embodiments and as noted above, the taxpayer may be presented with an amount for each paycheck applying the suggested income tax withholding 505 alongside a total withholdings for the entire tax period 501.

Embodiments of the invention may present a suggested income tax withholding through a recommended income tax withholdings form. One non-limiting embodiment instructs the taxpayer on how to complete a W-4 form or other income tax withholdings form. Based on the suggested income tax withholdings, the taxpayer will be instructed on what allowances and deductions to enter on the income tax withholdings form. For example, a W-4 form usually requires a “0,” “1,” or “2” for personal allowances and deductions. Thus, presenting the suggested income tax withholding includes presenting instructions on what to enter on a W-4. Instructions may also include what to enter on different lines on the deductions worksheet. The instructions may be presented either in written steps, e.g., enter “0” on line 5 of the W-4, via a completed W-4 presented on the GUI, via a video tutorial, etc.

Yet further embodiments automatically and electronically populate a W-4 form or other income tax withholdings form using the suggested income tax withholdings, which the taxpayer may then print or electronically provide to the taxpayer's employer or a payroll processor. In other embodiments, the taxpayer provides an instruction via the GUI to complete an income tax withholdings form according to the suggested tax withholdings. Moreover if multiple goals were specified, embodiments of the invention provide instructions on filling out multiple income tax withholdings forms or otherwise automatically populate the forms. Additionally, if a second income tax withholdings form is requested for a second goal, instructions may be presented informing the taxpayer on the appropriate date to file the second income tax form (i.e., when the second goal is set to be instituted). Moreover, the embodiment could e-mail or otherwise send a second income tax withholdings form that is automatically populated to the taxpayer, the taxpayer's employer, or a payroll processor.

As briefly noted above, embodiments of the invention may track any changes in the known tax information for the taxpayer and update the suggested income tax withholdings accordingly or otherwise inform the taxpayer that the taxpayer is or is not on track to realize the specified goal. In embodiments that track the known tax information throughout a tax period, such as via financial management software, the computer program of embodiments of the invention will update the suggested income tax withholdings and notify the taxpayer that, based on changes in the known tax information (e.g., a raise in income), the taxpayer's income tax withholdings form will need to be changed to realize the specified goal. The tracking of the known tax information and the updating of the suggested income tax withholdings may be performed proactively by the computer program of embodiments of the invention or upon the taxpayer's request. In general, the tracking of the suggested income tax withholdings may be performed at pre-set time intervals, such as monthly, quarterly, or bi-annually.

Embodiments of the invention may also be used to specify a goal for a multiple of income tax withholdings forms, for a multiple of preferred tax periods, for a multiple of individuals, or for a multiple of employers. For example, for a multiple-person household where multiple persons are employed, embodiments of the invention allow for the taxpayer to set the specified goal for the entire household or a portion thereof but otherwise use the taxpayer information for each person in the household. Thus, for a married couple filing jointly and both employed, embodiments of the invention allow the couple to establish a collective specified goal that includes the taxpayer information for both of them. There may be other taxpayer situations where an individual taxpayer receives income from multiple sources, such as multiple jobs, and desires to set the specified goal to include the multiple income sources. Embodiments of the invention allow the taxpayer to establish the specified goal for the collective taxpayer information associated with all of the sources of income or for each source individually. In yet further embodiments, the taxpayer may select a greater amount of income tax withholdings from one employer and a lesser amount of income tax withholdings from another employer.

Although in some embodiments the taxpayer may use the invention in conjunction with the taxpayer preparing a tax return, the taxpayer may alternatively be presented with the option to use the invention via financial management software, by a payroll processor, by a financial advisory, or by the taxpayer's employer. The computer program of embodiments of the invention may be accessed through an application on a computing device, as discussed above.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A non-transitory computer readable storage medium with a computer program stored thereon for enabling a taxpayer to specify a goal realized by the taxpayer's income tax withholdings, wherein the specified goal is for a preferred tax period and wherein the preferred tax period is at least a portion of a tax period for which the taxpayer pays income taxes, wherein the computer program instructs at least one processing element to perform the steps of:
receiving, from the taxpayer, information indicative of the specified goal realized by the taxpayer's income tax withholdings for the preferred tax period;
obtaining known tax information related to the taxpayer;
determining a tax liability for the taxpayer for the preferred tax period based on at least a portion of the obtained known tax information;
comparing the determined taxpayer's tax liability for the preferred tax period with the received information indicative of the specified goal realized by the taxpayer's income tax withholdings;
calculating, based on the comparing the taxpayer's tax liability with the received information indicative of the specified goal, a suggested income tax withholding that realizes the specified goal; and
providing, to the taxpayer, the suggested income tax withholding that realizes the specified goal.

2. The computer readable storage medium of claim 1, wherein the preferred tax period is either a current tax period, a remainder of the current tax period, or a tax period subsequent to the current tax period.

3. The computer readable storage medium of claim 2,
wherein the known tax information includes tax information for either or both of the current tax period to date or a prior tax period, and
wherein the known tax information includes income tax withholdings for either or both of the current tax period to date or the prior tax period.

4. The computer readable storage medium of claim 2, wherein when the preferred tax period is for the remainder of the current tax period, the determined tax liability is for the entire current tax period.

5. The computer readable storage medium of claim 1, wherein the computer program instructs the at least one processing element to perform the step of:
predicting at least some tax information for a remainder of the current tax period to date and related to the taxpayer's taxes, wherein the predicting is based at least in part on the known tax information,
wherein the determining said tax liability for the taxpayer for the tax period is based at least in part on said predicted tax information for said remainder of the current tax period to date.

6. The computer readable storage medium of claim 1, wherein the known tax information comprises tax information for a prior tax period and tax information for a current tax period to date.

7. The computer readable storage medium of claim 1, wherein the realizing the taxpayer's specified goal is within a pre-set tolerance of error.

8. The computer readable storage medium of claim 1, wherein the computer program instructs the at least one processing element to perform the steps of:
requesting, from the taxpayer, updated tax information that is indicative of any changes in the taxpayer's tax information from the immediately previous tax period; and
receiving, from the taxpayer, the updated tax information,
wherein said determining the tax liability for the taxpayer for the tax period based on at least a portion of the obtained known tax information includes determining the tax liability based on the updated tax information.

9. The computer readable storage medium of claim 1, wherein the computer program instructs the at least one processing element to perform the step of automatically completing a W-4 form for the taxpayer using the suggested income tax withholdings.

10. The computer readable storage medium of claim 1, wherein the specified goal is selected from the group consisting of: a specific tax refund amount for the tax period; an optimized income tax withholdings amount that realizes no tax liability for the tax period; and an optimized income tax withholdings amount that realizes a tax liability that does not incur a penalty from a government taxing authority.

11. The computer readable storage medium of claim 1, wherein the computer program instructs the at least one processing element to perform the step of:
providing, to the taxpayer, a graphical user interface that includes at least one selectively variable field related to the taxpayer's income tax withholdings,
receiving, from the taxpayer, a first input to the at least one selectively variable field,
wherein the first input is information related to the taxpayer's tax information for the tax period;
providing, to the taxpayer, the suggested income tax withholding based on the first input,
wherein the suggested income tax withholding is a first suggested income tax withholding;
receiving, from the taxpayer, a second input to the at least one selectively variable field,
wherein the second input is information related to the taxpayer's tax information for the tax period;
providing, to the taxpayer, a second suggested income tax withholding based on the second input,
wherein the first suggested income tax withholding is different than the second suggested income tax withholding, such that the taxpayer may receive different suggested income tax withholdings based on the taxpayer's input to the interface.

12. A method for enabling a taxpayer to specify a goal realized by the taxpayer's income tax withholdings, wherein the specified goal is for a preferred tax period and wherein the preferred tax period is at least a portion of a tax period for which the taxpayer pays income taxes, wherein the method comprises the steps of:
receiving, from the taxpayer, information indicative of the specified goal realized by the taxpayer's income tax withholdings for the preferred tax period;
obtaining known tax information related to the taxpayer;
determining a tax liability for the taxpayer for the preferred tax period based on at least a portion of the obtained known tax information;
comparing the determined taxpayer's tax liability for the preferred tax period with the received information indicative of the specified goal realized by the taxpayer's income tax withholdings;
calculating, based on the comparing the taxpayer's tax liability with the received information indicative of the specified goal, a suggested income tax withholding that realizes the specified goal; and
providing, to the taxpayer, the suggested income tax withholding that realizes the specified goal.

13. The method of claim 12, wherein the preferred tax period is either a current tax period, a remainder of the current tax period, or a tax period subsequent to the current tax period.

14. The method of claim 13,
wherein the known tax information includes tax information for either or both of the current tax period to date or a prior tax period, and
wherein the known tax information includes income tax withholdings for either or both of the current tax period to date or the prior tax period.

15. The method of claim 13, wherein when the preferred tax period is for the remainder of the current tax period, the determined tax liability is for the entire current tax period.

16. The method of claim 12, further including the step of:
predicting at least some tax information for a remainder of the current tax period to date and related to the taxpayer's taxes, wherein the predicting is based at least in part on the known tax information,
wherein the determining said tax liability for the taxpayer for the tax period is based at least in part on said predicted tax information for said remainder of the current tax period to date.

17. The method of claim 12, wherein the known tax information comprises tax information for a prior tax period and tax information for a current tax period to date.

18. The method of claim 12, wherein the realizing the taxpayer's specified goal is within a pre-set tolerance of error.

19. The method of claim 12, further including the steps of:
requesting, from the taxpayer, updated tax information that is indicative of any changes in the taxpayer's tax information from the immediately previous tax period; and
receiving, from the taxpayer, the updated tax information,
wherein said determining the tax liability for the taxpayer for the tax period based on at least a portion of the obtained known tax information includes determining the tax liability based on the updated tax information.

20. The method of claim 12, wherein the specified goal is selected from the group consisting of: a specific tax refund amount for the tax period; an optimized income tax withholdings amount that realizes no tax liability for the tax period; and an optimized income tax withholdings amount that realizes a tax liability that does not incur a penalty from a government taxing authority.
